(19) United States
(12) Patent Application Publication
(10) Pub. No.: US 2008/0170154 A1
(43) Pub. Date: Jul. 17, 2008

(54) Head removable camera

(75) Inventors: Kazuyoshi Yamada, Kasugai-shi (JP); Takeshi Yoshida, Nagoya-shi (JP); Ken Shimizu, Inuyama-shi (JP)

Correspondence Address: Quinn Emanuel Urquhart Oliver & Hedges, LLC;Koda/Androlia, 10th Floor, 865 S. Figueroa Street, Los Angeles, CA, 90017, US

(73) Assignee: Elmo Co., Ltd.

(21) Appl. No.: 12/004,425

(22) Filed: Dec. 20, 2007

(30) Foreign Application Priority Data
Dec. 27, 2006 (JP) P2006-351732

(51) Int. Cl. H04N 5/225; G03B 17/02; G03B 17/08

(52) U.S. Cl. 348/373; 396/541; 396/25; 348/E05.024

(57) ABSTRACT

A head removable camera includes a signal input/output cable having a distal end, a housing including a rear end to which the signal input/output cable is connected and a front end formed with an opening, an image pickup device housed in the housing, a lens unit housed in the housing so as to be disposed in front of the image pickup device, a first cap attached to the opening of the housing front end and including a front glass fitted therein, and a second cap in which a predetermined conversion lens is fitted, the second cap being attached to the opening of the housing front end instead of the first cap.

### CROSS-REFERENCE TO RELATED APPLICATIONS

This application is based on and claims the benefit of priority from the prior Japanese Patent Application No. 2006-351732, filed on Dec. 27, 2006, the entire contents of which are incorporated herein by reference.

### BACKGROUND OF THE INVENTION

1. Field of the Invention

The present invention relates to a head removable camera.

2. Description of the Related Art

Head removable cameras have conventionally been developed which comprise a housing, an image pickup device and a lens unit latter two of which are housed in the housing. The housing has a rear end to which a distal end of a signal input/output cable is connected. The lens unit is disposed in front of the image pickup device. For example, Japanese Patent No. 3020087 discloses a head removable camera in which a camera head is housed in a waterproof casing together with a camera head housing.

A several types of camera heads are prepared in order that an imaging field angle may be changed for plural purposes in the head removable cameras. A signal input/output cable is re-connected to a camera control unit so that a predetermined purpose is achieved. Furthermore, plural interchangeable lens are also prepared for plural purposes. One lens unit is changed to another lens unit so that a predetermined purpose is achieved.

However, plural camera heads need to be prepared according to the number of purposes, or a plurality of interchangeable lens need to be prepared according to the number of purposes. These camera heads or interchangeable lens are expensive and are uneconomical.

### SUMMARY OF THE INVENTION

Therefore, an object of the present invention is to provide a head removable camera which can change an imaging field angle for a plurality of purposes and yet which is moderate in costs and economical.

The present invention provides a head removable camera comprising a signal input/output cable having a distal end, a housing including a rear end to which the signal input/output cable is connected and a front end formed with an opening, an image pickup device housed in the housing, a lens unit housed in the housing so as to be disposed in front of the image pickup device, a first cap attached to the opening of the housing front end and including a front glass fitted therein, and a second cap in which a predetermined conversion lens is fitted, the second cap being attached to the opening of the housing front end instead of the first cap.

Several types of caps are prepared in which conversion lenses are fitted respectively. One of the caps is attached to the front opening of the housing instead of the cap in which the front glass is fitted. Consequently, since a plurality of camera heads or interchangeable lenses need not be prepared, the head removable camera which is moderate in costs and economical can be provided.

In one embodiment, the conversion lens is a single element lens. Consequently, the camera can further be rendered moderate in costs and economical.

In another embodiment, the housing, the cap and a joint between the housing and the cap are waterproofed. Consequently, the head removable camera can be used in water and outdoors and thus, the use range of the camera can be enlarged.

### BRIEF DESCRIPTION OF THE DRAWINGS

Other objects, features and advantages of the present invention will become clear upon reviewing the following description of the embodiment with reference to the accompanying drawings, in which:

FIG. 1 is a perspective view of the head removable camera in accordance with one embodiment of the present invention;

FIG. 2 is a block diagram showing an electrical arrangement of the head removable camera;

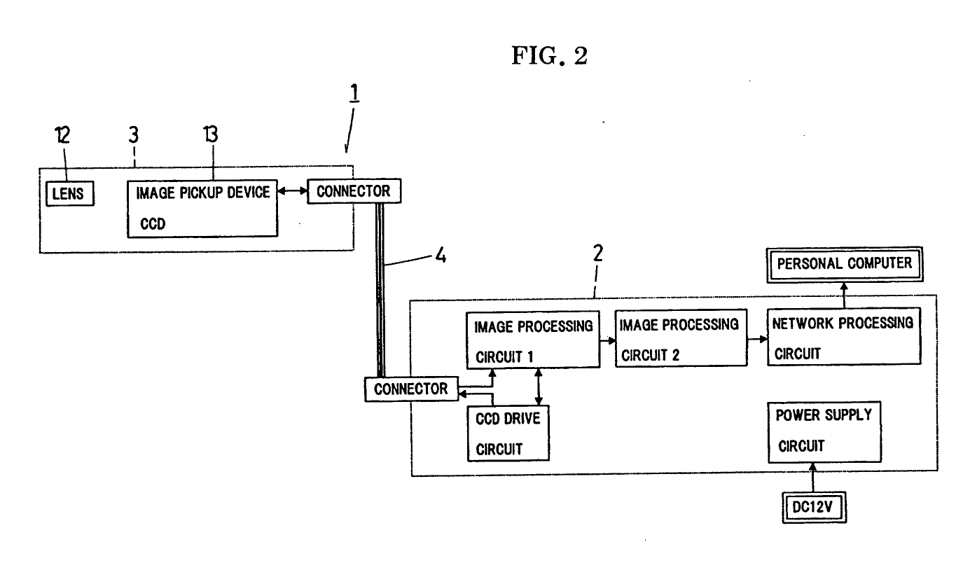

FIG. 3 is a sectional view of the camera head; and

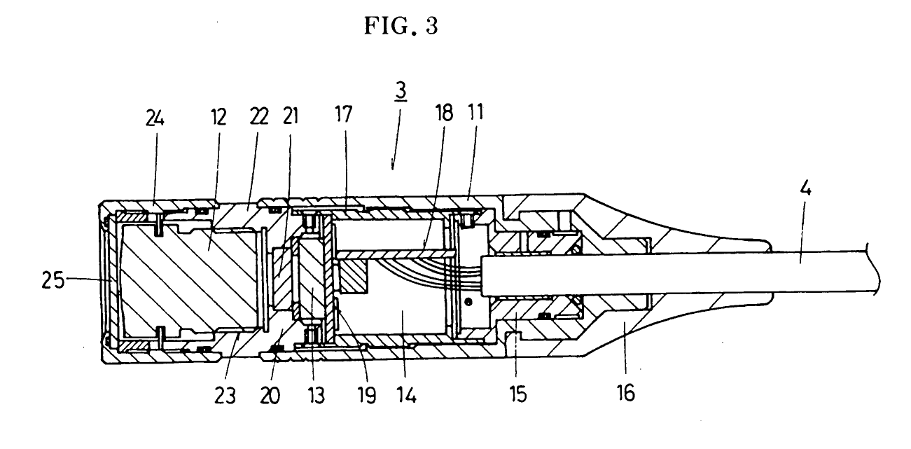

FIG. 4 is a sectional view of the camera head to which a cap with a conversion lens is attached.

### DETAILED DESCRIPTION OF THE INVENTION

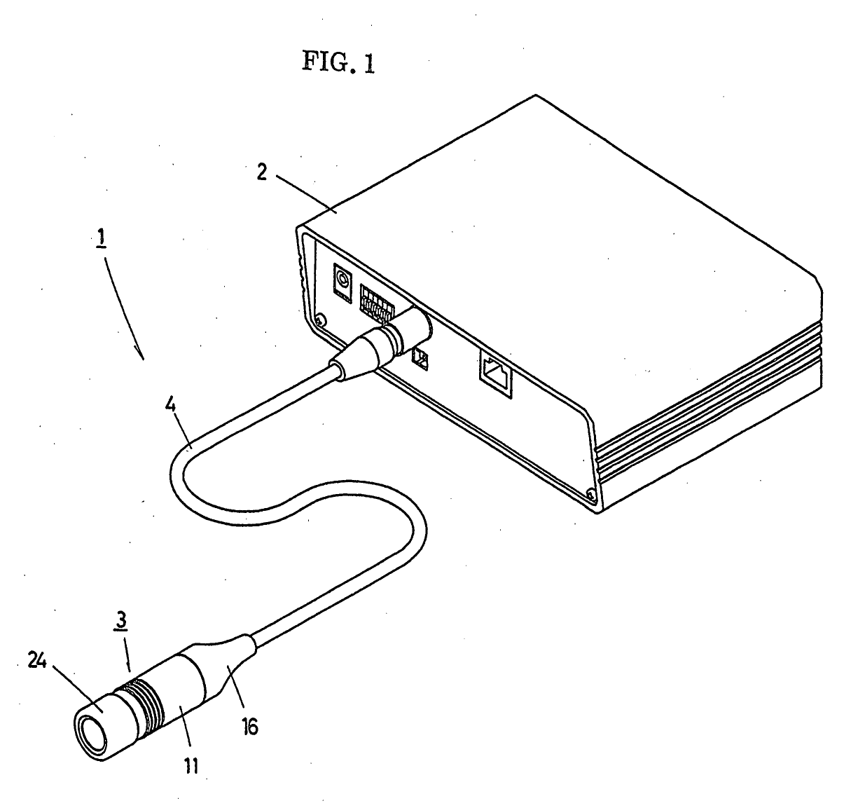

One embodiment of the present invention will be described with reference to the accompanying drawings. Referring to FIG. 1, a head removable camera 1 comprises a control unit 2 and a camera head 3. The camera head 3 includes an input/output cable (hereinafter, “cable”) 4 which connects the camera head 3 to the control unit 2. The control unit 2 includes a CCD drive circuit, image processing circuits (1) and (2) both of which processes a picture signal delivered from the CCD 13, a network processing circuit, a power supply circuit and the like.

The camera head 3 mainly comprises a housing 11, a lens unit 12, a CCD 13 and a CCD unit 14, the latter three of which are housed in the housing 11. A cable holder 15 is fixed to a rear end of the housing 11. The cable 4 is inserted through the cable holder 15 thereby to be held. A rubber sleeve 16 is fitted with an outer periphery of the rear end of the housing 11 and a part of the cable 4. The CCD unit 14 includes a board holder 17 fixed so as to be disposed in front of the cable holder 15 in the housing 11. The CCD unit 14 includes a circuit board 18 and a CCD board 19 both of which are mounted on the board holder 17.

A CCD holder 20 is fitted in a front end opening of the housing 11 and further fixed to the board holder 17. The CCD 13 is held by the CCD holder 20, and an optical quartz-crystal filter 21 is mounted so as to be located forward the CCD 13. Furthermore, the CCD 20 includes a cylindrical portion 22 protruding form the front end opening of the housing 11. The cylindrical portion has an inner circumference formed with a female screw 23. The lens unit 12 has a rear end screwed onto the female screw 23, whereby the lens unit 12 is mounted on the housing 11. The lens unit 12 has a front end further having an outer periphery with which a cap 24 is threadingly engaged thereby to cover the front end of the lens unit. The cap 24 has an opening in which a front glass 25 is fitted.

Two O-rings are fitted with a joint between the housing 11 and the cable holder 15 and the housing 11 and the CCD holder 20 respectively. Another O-ring is fitted with a joint between the CCD holder 20 and the cap 24. A further another O-ring is attached to a fitted portion of the cap 24 and the front glass 25. Thus, the whole camera head 3 is waterproofed.

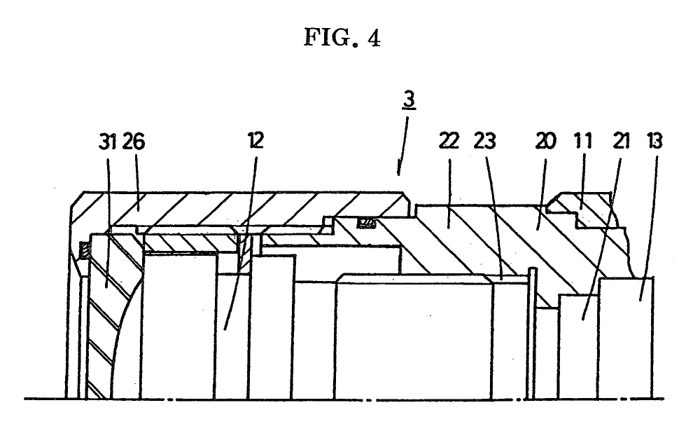

The cap 24 with the front glass 25 is attached to the camera head 3 as shown in FIG. 4. However, a cap 26 having a single element conversion lens 31 fitted therein can be threadingly engaged with the outer circumference of the front end of the CCD holder 20, instead of the cap 24. In this case, since the conversion lends 31 is a concave lens, a field angle is increased such that the camera head is specified as a wide-angle mode. When a plurality of caps provided with different types of conversion lenses are prepared and exchanged in use, the camera head can easily be changed into various imaging modes such as a telephoto mode.

According to the above-described embodiment, a plurality of types of caps 20 in which different conversion lens are fitted are prepared. Each cap 26 can threadingly be engaged with the outer circumference of the front end of the CCD holder 20 fixed to the housing 11. Accordingly, since a plurality of camera heads or interchangeable lenses need not be prepared, the head removable camera which is moderate in costs and economical can be provided. Furthermore, since the conversion lens is a single element lens, the camera can further be rendered moderate in costs and economical. Additionally, since the whole camera head 3 is waterproofed, the head removable camera can be used in water and outdoors and thus, the use range of the camera can be enlarged.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

1. A head removable camera comprising:
a signal input/output cable having a distal end;
a housing including a rear end to which the signal input/output cable is connected and a front end formed with an opening;
an image pickup device housed in the housing;
a lens unit housed in the housing so as to be disposed in front of the image pickup device;
a first cap attached to the opening of the housing front end and including a front glass fitted therein; and
a second cap in which a predetermined conversion lens is fitted, the second cap being attached to the opening of the housing front end instead of the first cap.

2. The head removable camera according to claim 1, wherein the conversion lens is a single element lens.

3. The head removable camera according to claim 1, wherein the housing, the cap and a joint between the housing and the cap are waterproofed.

4. The head removable camera according to claim 2, wherein the housing, the cap and a joint between the housing and the cap are waterproofed.
